(19) United States
(12) Patent Application Publication
(10) Pub. No.: US 2019/0236485 A1
(43) Pub. Date: Aug. 1, 2019

(54) ORCHESTRATION SYSTEM FOR DISTRIBUTED MACHINE LEARNING ENGINES

(71) Applicant: Cisco Technology, Inc., San Jose, CA (US)

(72) Inventors: James D. Stanley, III, Austin, TX (US); Carlos M. Pignataro, Cary, NC (US); Plamen Nedeltchev Nedeltchev, San Jose, CA (US); Victoria Mayhall Blaylock, Carrollton, GA (US); Andrea Gold, San Jose, CA (US); Prabhat Bhattarai, San Jose, CA (US)

(21) Appl. No.: 15/880,611

(22) Filed: Jan. 26, 2018

(51) Int. Cl. G06N 99/00; H04L 29/08

(52) U.S. Cl. CPC G06N 99/005; H04L 67/10

(57) ABSTRACT

Presented herein are techniques for managing a plurality of machine learning engines. A method includes receiving at an orchestration entity information descriptive of attributes of a plurality of machine learning engines, generating, based on the information, a unique signature for each machine learning engine of the plurality of machine learning engines, creating, based on the unique signature for each machine learning engine, an ensemble of machine learning engines configured to operate on a predetermined task, causing the ensemble of machine learning engines to operate on the predetermined task, and monitoring performance metrics of the machine learning engines in the ensemble of machine learning engines while the ensemble operates on the predetermined task.

### TECHNICAL FIELD

The present disclosure relates to managing and combining the functionality and outputs of a plurality of machine learning engines.

### BACKGROUND

Evolved from the study of pattern recognition and computational learning theory in artificial intelligence, machine learning explores the study and construction of algorithms that can learn from and make predictions on data. Such an approach differs from following strictly static program instructions by making data-driven predictions or decisions, through building a model from sample inputs. Machine learning is employed in a range of computing tasks where designing and programming explicit algorithms with good performance is difficult or infeasible. Example applications include email filtering, detection of network intruders or malicious insiders working towards a data breach, optical character recognition (OCR), learning to rank, and computer vision.

### BRIEF DESCRIPTION OF THE DRAWINGS

FIG. 1 depicts a communications network in which machine learning (ML) module orchestration may be deployed in accordance with an example embodiment.

FIG. 2 is a block diagram illustrating functionality of the ML module orchestration logic and entities with which the logic might interact in accordance with an example embodiment.

FIG. 3 illustrates several approaches that can be employed to determine which ML modules might be combined into an ensemble to operate on a predetermined task in accordance with an example embodiment.

FIG. 4 illustrates an approach to managing an ensemble of ML modules in accordance with an example embodiment.

FIG. 5 is a block diagram illustrating that ML module orchestration logic can be used across a variety of logical and physical boundaries in accordance with an example embodiment.

FIG. 6 is a flow diagram that depicts operations associated with generating a fingerprint or unique signature for a given ML module in accordance with an example embodiment.

FIG. 7 is a block diagram illustrating functionality in connection with generating a fingerprint or unique signature for a given ML module in accordance with an example embodiment.

FIG. 8 illustrates examples of avenues via which different attributes for a fingerprint may be gleaned in accordance with an example embodiment.

FIG. 9 is a logical representation of a database that stores information about individual ML modules in accordance with an example embodiment.

FIG. 10 is a flowchart that depicts operations that may be performed by ML module orchestration logic in accordance with an example embodiment.

FIG. 11 shows how ML brokers might be distributed across a network and geographical space in accordance with an example embodiment.

FIG. 12 depicts an apparatus on which ML module orchestration logic may be hosted in accordance with an example embodiment.

### DESCRIPTION OF EXAMPLE EMBODIMENTS

### Overview

Presented herein are techniques for managing a plurality of machine learning engines. A method includes receiving at an orchestration entity information descriptive of attributes of a plurality of machine learning engines, generating, based on the information, a unique signature for each machine learning engine of the plurality of machine learning engines, creating, based on the unique signature for each machine learning engine, an ensemble of machine learning engines configured to operate on a predetermined task, causing the ensemble of machine learning engines to operate on the predetermined task, and monitoring performance metrics of the machine learning engines in the ensemble of machine learning engines while the ensemble operates on the predetermined task.

Also presented herein is a device including an interface unit configured to enable network communications, a memory, and one or more processors coupled to the interface unit and the memory, and configured to receive information descriptive of attributes of a plurality of machine learning engines, generate, based on the information, a unique signature for each machine learning engine of the plurality of machine learning engines, create, based on the unique signature for each machine learning engine, an ensemble of machine learning engines configured to operate on a predetermined task, cause the ensemble of machine learning engines to operate on the predetermined task, and monitor performance metrics of the machine learning engines in the ensemble of machine learning engines while the ensemble operates on the predetermined task.

### Example Embodiments

Embodiments described herein provide a dynamic system that controls and orchestrates disparate, multi-author, multi-math, and algorithm-based mathematical machine learning (ML) engines or modules (the terms “engine(s)” and “module(s)” are hereinafter used interchangeably). The management of ML engines is distributed throughout the network in a sematectonic manner, in which the ML engines can be reconfigured individually or in groups (as (an) “ensemble(s)”) based on a predetermined task to be performed and/or in view of changing conditions within the environment. This orchestration system, embodied in “ML module orchestration logic,” allows for controlled, self-adaptive, and continuous operations of the ML modules locally within the network, whether connected or disconnected.

Existing machine learning approaches leverage single mathematical data science models to achieve a specific result, such as regression, association rule learning, random forest, or decision tree models. Combining approaches and models derives more advanced insights with higher probabilistic statistics supporting a certain action or event. However, interoperability and communication between different models becomes challenging due to differing techniques, authors, attributes, and other variables. Therefore, ML modules are conventionally deployed in silos with their respective unique math-based approaches of data scientists, 3^{rd} party software, and applied math-based calculations. These silos limit the advantages of combining the techniques from different origins to achieve a higher quality outcome. As silos increase, operational expenses, time to market, and resource deployment challenges also increase for customers.

As the sophistication of machine learning techniques increases for distribution across network nodes (e.g., compute, virtual machine, or edge device), there is a need for management of the heterogeneous machine learning engines, which are a series of software components that are distributed across networks to execute at some distributed node across networks. These ML engines, whether container, micro-service, or virtual machine (VM)-like, may self-execute without the need of a central cloud or data center. Management and orchestration of the underlying resources that support these ML engines includes identifying how and when to combine ML engines for a specific purpose, whether pre-planned, ad hoc, reactive, and/or through pre-emptive autonomic self-healing. Such a combination of ML engines is referred to as an “ensemble.” Stated alternatively, an ensemble is a technique for combining ML modules to increase the quality of the derived outputs and insights.

As inferred previously, further complicating the distributed nature of ML engines is a common misconception that data must be centralized and stored in a single big data repository, such as Hadoop or Teradata, before analysis can occur. In fact, most existing big data and analytics software offerings and approaches rely on robust computing platforms that centrally ingest data and then apply script-based data science models based on R or Python, rather than stronger software code, such as C or C++. Increasing computing power and human resources leads to higher capital and operational costs, and are missing the emergence of software ML engines that are useful across multiple use cases without model manipulation or customization. It is anticipated that, over time, there will be more generalized “rinse/repeat” software ML engines distributed across networks, and thus there will be a need to orchestrate participants and the service chains that support those participants. The embodiments described herein address this need.

Traditional and centralized machine learning approaches are not sustainable or scalable long-term, nor are they effective for distributed or edge use cases that are emerging from increasing Internet of Things (IoT) connections because they lack the sophistication of distributed micro-services and advanced mathematical machine learning algorithms. For example, individual utility meters within utility environments collect large amounts of data per day (estimated 24 TB) that is mostly being used today for billing purposes only. Yet, this data proves very valuable for improving operations and optimizing field decisions, such as notifying customers of outages and restoration events within minutes, instead of hours. In order to provide such service efficiently, data processing and analytics are preferably performed on the meter devices themselves, rather than backhauling data to a central repository or cloud environment for that processing. Processing the data at the edge filters out critical data needed for action execution, which optimizes time to insight and decreases the amount of data transmitted back to the central repository. Ultimately, the key problem to solve is how to orchestrate a distributed and adaptive machine learning system that executes in proximity or as close as possible to the edge, where the data is created.

In another use case, in the intellectual asset protection systems of any enterprise, any platform will handle massive amounts of data and ever changing sources of data—from devices, sensors, users and other entities. This complexity lends itself to machine learning orchestration of different ML engines as described herein to determine normal and abnormal behavior for cybersecurity purposes. For example, an asset protection system at a company may contain user information, files, server details, intellectual property, processes, etc. Properly profiling this data to enable analysis is critical, yet requires different machine learning techniques for binary multidimensional classification across the different types of behavior. For example, sensor behavior may be substantially different from a user's behavior. This is true even among different classes of sensors. A humidity sensor has a different profile of normal behavior compared to a light sensor, for example. Applying ML engines in an orchestrated fashion in accordance with the embodiment described herein may better determine or identify normal and abnormal behavior.

Similarly, while many machine learning systems today enable alerts and notifications, such alerts and notification may not be connected to the binary decision points. This can lead to break downs when the binary actions cannot be applied across multiple uses. For example, within the transportation industry, an action to avoid a physical obstacle for a train may be to “Stop”, yet for an airplane stopping the plane 30,000 feet in the air would be catastrophic. Using a machine learning engine ensemble approach, as described herein, with multidimensional classifiers, the ML engines can be applied based on different conditions and can learn from each other. By leveraging dynamic ML engines, machines can take more dynamic actions depending on varying conditions.

The following terms are defined for purposes of this disclosure:

Machine learning engine or module (referred to herein as “ML engine” or “ML module”): A distributed set of software executable code that utilizes math-based algorithmic techniques for performing analysis on data (e.g., self-running machine learning executable run in memory or on disks). In the context of the embodiments described herein, an ML engine is a participant within the system and can be executed, transacted, and/or combined to form “ensembles.” In the world of networks, these self-executing software elements perform their roles and activities distributed throughout network nodes or devices. ML engines operate independently on specific tasks and may operate without relying on big data, cloud, data center, or large-scale centralized or regional compute clusters to perform their math-based data analysis. Embodiments described herein are configured to manage the distributed machine learning that impacts network devices, mobile devices, IoT, defense, gaming, and many other purpose-configured network nodes.

Machine learning swarm hypervisor (or “hypervisor”): A computer-based software system that manages machine learning software executable code based on unique identifiers and metadata.

Machine learning orchestrator master: An orchestration software system executing on hardware that utilizes self-learning and performance attributes to orchestrate the workflows associated with grouping or clustering distributed machine learning software code, i.e., ML modules.

Orbital neighborhood: A collective grouping or community of edge devices that are physically, virtually, and/or logically close in proximity based on established parameters of the networked environments. In the context of the instant embodiments, edge nodes that are within a neighborhood would be able to offload or share tasks based on unique fingerprints assigned to ML engines within those devices or virtual instances. For example, utility meters within close proximity (e.g., neighborhood, communities, within a postal code or clustering of postal codes), would be considered a neighborhood, and based on specific characteristics or events, these devices could communicate to each other via ML engines.

Machine learning broker (ML broker): A distributed publish-subscribe messaging system that enables communication between a producer of data or messages and a consumer of that content (e.g., Apache Kafka as a reference of existing art approaches for data publishing). In the instant embodiments, the ML broker within the orchestration system functions as an extension of the system to communicate with the ML engines, and is self-operating. Further the ML broker incorporates broker to broker communications and handshakes that allow for distributed broker to broker communication. An ML broker may incorporate ML signatures as part of handshake exchanges.

Ensemble: A method or technique for, and result of, combining two or more machine learning algorithms, models, or engines to improve the statistical viability of the result and outcome for the customer. A resulting ensemble may comprise multi-author and 3^{rd} party machine learning engines.

Sematectonic: The ability of a software element to perform processes based on activity and/or actions learned through math-based interrogation methods and algorithms. These methods monitor and improve communications across the system to help organize swarms of distributed software micro-services and guide potential additional workloads.

Fingerprinting: A process to identify and assign unique attributes and characteristics for a ML module (including its software code) that can be used by a management system, e.g., the hypervisor.

Resource manager: A top-level software manager of distributed ML engines within an orchestration system that enables the combination of multi-vendor, multi-author, multi-publisher, and multi-origin software executables. It tracks the availability of resources to combine, pair, and execute within the system. It then informs the resource layer supply and demand factors via APIs to other management and orchestration systems that manage the service chain full stack IT-based resource facing services.

Multi-scopic model: Through a series of dimensional evaluation and comparison techniques, multi-scopic models refer to the dimensional slices and inferred dimensional slices to allow for a multi-dimensional evaluation, interrogation, and viewing of the data associated with the ML engines and the orbital neighborhoods. The models idealize data attributes and features portrayed at more descriptive and reduced scaled aspects for better understanding—in essence particle forms of analysis at varying scales to help in the observable ratio of visible, inferred, and varying magnitude of particles and their relationships.

The embodiments described herein comprise software system-based modules and functions that are purpose built for distributed ML engine orchestration, automation, management, and most importantly, ensemble swarming. These modules and functions allow for a real-time dynamic system that manages the lifecycle of not just the ML engines that participate in the neighborhoods and networked communities, but also the entwined dynamically adaptive ecosystem of ensemble instances that take place in the system and its authoritative parameters. These ensemble instances of ML modules, whether planned, passive/active response, or adaptive/behaviorally learned overtime, may have a series of lifecycle service chaining functions to support their execution. Further, the overall ML swarm system may be configured to continuously seek to learn and adapt the system through a series of interrogation functions that utilize ensemble techniques to derive insights for optimization, performance, monetization, and other such value outcomes to improve assurance, experience, and value returned.

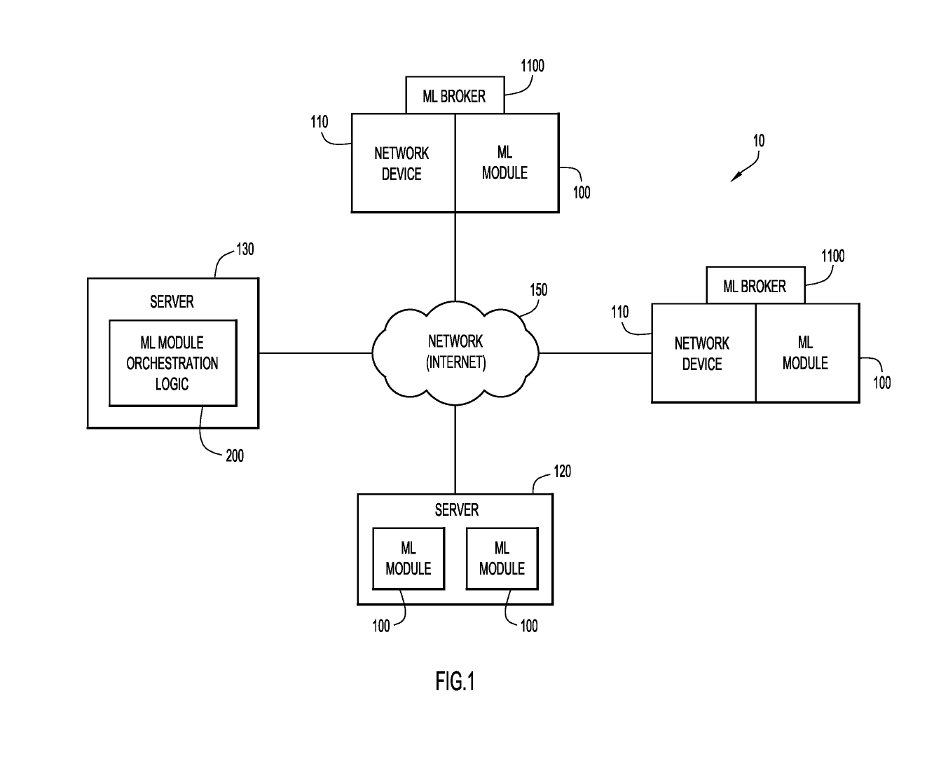

FIG. 1 depicts an electronic communications network 10 in which machine learning (ML) module orchestration logic 200 may be deployed in accordance with an example embodiment. A network 150, such as the Internet, enables communication among network devices 110, server 120 and server 130. As shown, one or more ML modules 100 may be deployed at each of the nodes and may be configured to run autonomously. As an example, network device 110 and server 120 might be associated with smart utility meters. Server 130 hosts ML module orchestration logic 200, which, as will be explained in detail below, is configured to learn about the deployed ML modules 100, determine how best to combine them in ensembles, interrogate data flows, and manage how respective outputs of the ML modules might be combined or processed, among other functions. An ML broker 1100 may be deployed with selected ML modules 100 to enable connectivity between ML brokers 1100 and between a given ML broker and ML module orchestration logic 200.

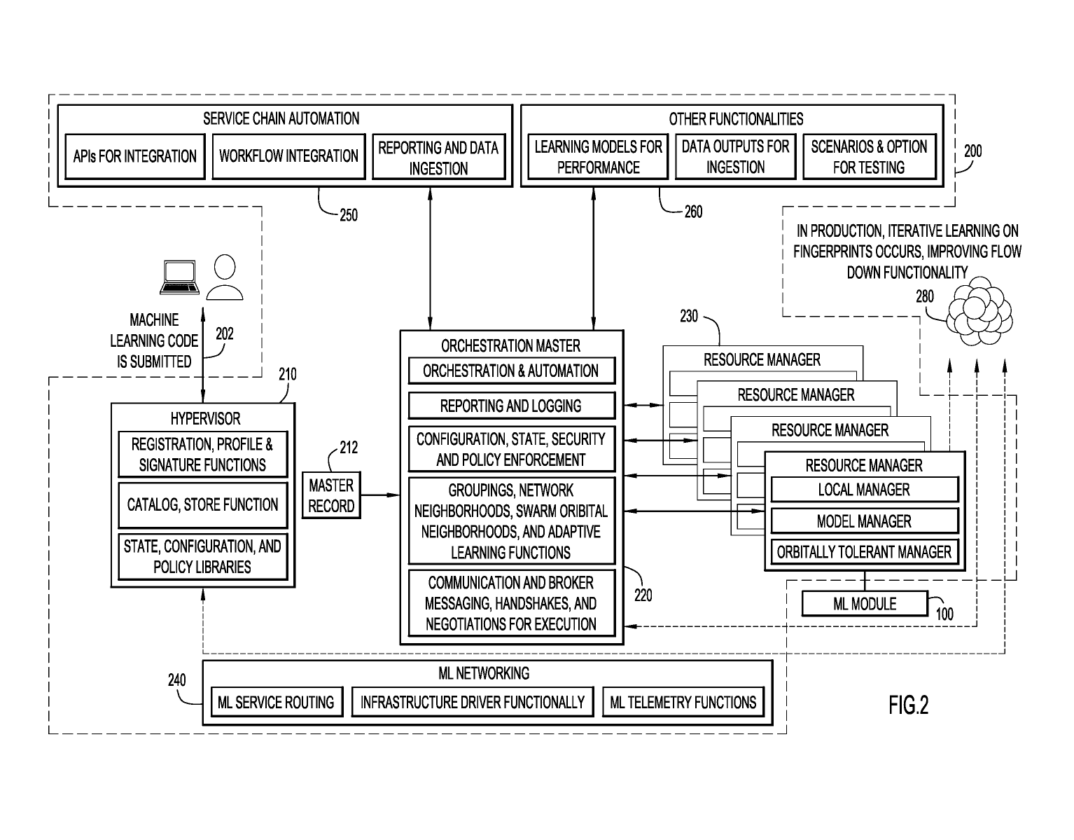

FIG. 2 is a block diagram illustrating functionality of ML module orchestration logic 200 and entities with which the logic 200 might interact in accordance with an example embodiment.

Specifically, a hypervisor 210 facilitates the participation of multi-party, multi-author, multi-type distributed machine learning software elements that operate independently or as swarming clusters. Hypervisor 210 oversees the lifecycle of registering, onboarding, testing, workflow automation, management orchestration, system communications, and service chain lifecycle management for multi-variant machine learning engines into virtualized swarms of in memory micro-service instances distributed across networked nodes.

For example, hypervisor 210 may be configured to onboard and register ML modules 100, provided by users at 202, via a registration, profile and signature function component. That is, hypervisor 210 is configured to identify attributes of the software code and user inputs, and establishes a ML engine profile. An example ML engine profile may include a unique signature (e.g., a fingerprint, which is discussed more fully later herein) and identifiable attributes, both user defined and mathematically calculated through software interrogation and inspection, for ML engines to be distributed and managed.

Hypervisor 210 may also be configured to store instances of the ML modules 100 using a catalog and store component.

Hypervisor 210 may also be configured to maintain the inventory and databases associated with ML engine profile information, and couple this information with overall participation parameters, such as configuration, state, security, and policies. These parameters may be continuously adapted to the evolving system, and the adaptations may be math-based learnings with both manual and automated improvements. After onboarding, the profiles or fingerprints may be continuously updated to reflect the dynamic system and lifecycle insights per ML engine and per ML ensemble.

As further shown in FIG. 2, an orchestration master 220 is in communication with hypervisor 210. Hypervisor 210 may, for example, pass a master record 212 to orchestration master 220 that includes the information collected initially and over time about a given ML module 100 that is being tracked and deployed in accordance with the embodiments described herein.

Orchestration master 220 is configured to assist in service chain workflow management for each ML engine 100 and the associated conditions or information an ML engine 100 relies upon. This functionality may include network facing, IT resource facing, customer service facing, ensemble facing, and overall lifecycle functions. These functions allow for the each ML engine 100 and/or ML engine ensemble to participate and be orchestrated for service automation and assurance purposes. Workflow management may comprise several functions, including, for example, lifecycle management of multiple ML engines distributed throughout networked environments, orchestration in the form of distribution, performance management, resource automation, policy/configuration management, and local ML provisioning and self-operations without substantial reliance on big data, cloud, or centralized management. Local environments (e.g., on an oil rig, a manufacturing floor, or service provider central office in a region, etc.) might have edge service creation and automated self-provisioning on the fly based on passive/active programming, policies, and/or event workflows. The foregoing functions may be performed by, for example, the orchestration and automation component of orchestration master 220 shown in FIG. 2. A reporting and logging component may also be provided, as shown, to keep track of the dynamic operations of the overall system.

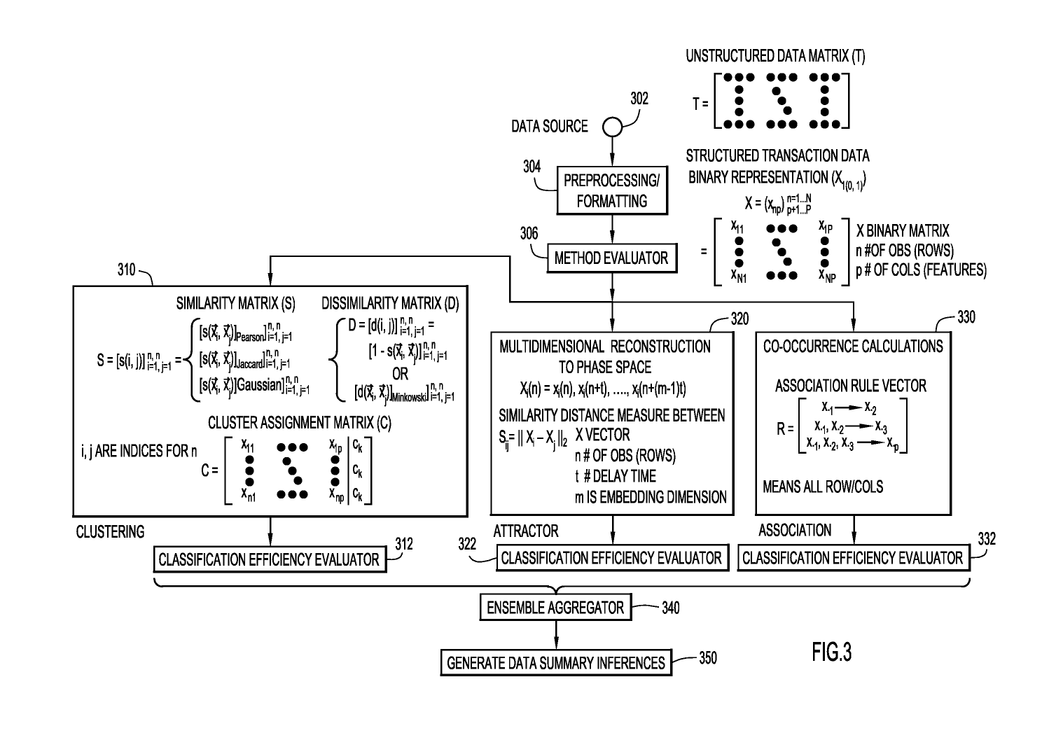

A configuration, state, security and policy enforcement component of orchestration master 220 may execute authority or master state configurations, which incorporate calculations of the intersection of ML engine profiles, location/neighborhood, participant status and potential ensemble instance memberships (discussed with reference to FIG. 3), policy and security, and other factors. Orchestration master 220 may be configured to maintain a master state configuration for real-time operations. It may also distribute the configuration(s) to various entities of the system that need all or a part of the state to execute their function and operations (e.g., a state configuration file may be distributed to resource managers 230 to manage resource ebbs and flows per the parameters in the state configuration file). For example, orchestration master 220 may distribute state configurations to resource managers 230 that are responsible for managing given ML engines 100 via a local manager, model manager, and orbitally tolerant manager, as indicated in FIG. 2.

A grouping, network neighborhoods, swarm orbital neighborhoods, and adaptive learning functions component of orchestration master 220 may incorporate simple and sophisticated intelligence recommendations and automation for combining multiple ML engines for passive and active situations, allowing for multi-vendor integration opportunities and merged mathematical ensembles to increase statistical, neural, and mathematical derived outcomes/insights in the data. For example, FIG. 3 illustrates several approaches that can be employed to determine which ML modules might be combined into an ensemble to operate on a predetermined task in accordance with an example embodiment. Using the information provided via 202, i.e., starting with a data source 302, orchestration master 220 may, at 304, perform preprocessing and/or formatting of the data. This operation may result in, e.g., a unique signature or fingerprint for each ML engine. A method evaluator 306 may then be employed to determine which of, e.g., three possible ensembling approaches or techniques might be selected: clustering 310, attractor 320 and/or association 330. Results of each technique are then passed through a respective classification efficiency evaluator 312, 322, 332, whereupon an ensemble aggregator 340, using the information provided, is configured to form a given ensemble. At 350, a data summary and inferences are generated to provide information regarding the basis of any final ensemble.

Referring again to FIG. 2, a communications and broker messaging, handshakes, and negotiations for execution component of orchestration master 220 is configured to manage the state within given parameters. More specifically, this component may interact and maintain local neighborhood communication, messaging, handshakes, and negotiations between ML engine participants and the overall swarm system 280. The component may further manage resources, such as network, compute, and storage. Further still, this component may include ML engine specific sets of instructions that help in each state managed, wherein the instruction may indicate a minimum intent, or may be declarative or mechanistic. In this context, declarative is a set recommended state, whereas mechanistic is a mechanical adaptive state based on learnings within the system to improve overall experience of the participants.

The communications and broker messaging, handshakes, and negotiations for execution component of orchestration master 220 may also be configured to identify and determine a range of mechanistic states. This process is part of the sematectonic approach on which the described embodiments may be based. For example, the system may incorporate functions that continuously interrogate the data, flows, and the associated behavioral signatures, including consumption patterns and trends. Continuous interrogation enables the system to identify, characterize, operationalize, and report out a range of optimizations, such as performance, ML swarming/ensembles, and additional work for the system itself in mechanistic approaches overtime. In one embodiment, the system is a learning system that evolves from intent to declarative to mechanistic over time, and the ebbs and flows of behavior is analyzed for workloads and ensemble instances. Sematectonic methods in accordance with an embodiment incorporate a series of math-based calculations and algorithms that 1) abstract and continuously learn the variances, attractors, varying risk/reward thresholds, and conductance of the flowing of data; 2) interact within the system streams; and 3) execute the participant instances within the system's range of influence and management.

It is noted that there may be unique methods in how network elements perform and facilitate microscale ML mixing and learning, along with automated and orchestrated local ML threshold violation detection for training an authoritative model. Such a model may distribute orchestration instances out of a central repository to ensure rapid scale and performance for the distributed ML engines 100 and their environmental needs.

Referring still to FIG. 2, ML networking 240 provides routing insertion to ML engine tags and prioritization configuration based on a series of service routes, infrastructure driver functionality, ML telemetry functions, orchestration flow messaging, and other network or communication infrastructures that support the ML engine workflows and orchestrated instances.

Service chain automation functions 250 and other functionalities 260 of ML module orchestration logic 200 may further provide a series of API, workflow integration and reporting and data ingestion components, as well as learning models for performance, data outputs for ingestion and scenarios and options for testing components. These functions allow for more integration into 3^{rd} party orchestration and automation systems, along with export ability for reporting, monitoring, event handling, and data ingestion.

The outputs of the system, e.g., from the data outputs for ingestion component in 260, are the direct results of the derived and generated insights based on the multi-facets at each sub-component level of the calculations, math-based ensembles, and learned awareness of the system operations. The outputs themselves might be passed through yet another set of ML modules, different from edge deployed ML engines, to improve probabilities of identifying a certain action or event.

Users can benefit from insights into which ML engine ensembles are possible, work best, and are ranked by the system or users. For example, generated ML engine ensemble catalogs may be useful for users to adjust their ML engine services and/or potentially exchange with other 3^{rd} party partners, customers, or independent users that may want to barter, trade, or transact on the ML engine or ML engine ensemble instances.

In an embodiment, actions are provided in the form of indices, recommendations, scenarios, and other outputs to human and machine readable formats to allow human or machine users to take action. For example, a user could adjust the capacity of a sub-system or replicate a successful ML ensemble to another location (e.g., replicate to other oil rigs). A system can take in the data or passive/active recommendations and automatically generate update configurations, states, and policies that are automatically redistributed. Either the automatic approaches can be programmed ahead of time to occur, or the system can be configured to have the authority to take mechanistic like action (e.g., grant authority to automate, replicate, etc.). Over time, as more neural network intelligence evolves, autonomic system automation may be incorporated to account for the master authority for service chain self-healing beyond the established mechanistic approaches.

As further shown in FIG. 2, in production, ML engines operating as a swarm 280 in the field, may be in communication with hypervisor 210, orchestration master 220, and/or respective resource managers 230 so that fingerprints can be updated and ensembles and orbital neighborhoods can be adjusted as warranted.

From the foregoing, those skilled in the art will appreciate that the embodiments described herein provide a series of software systems, modules, and functions that facilitate the participation of multi-party, multi-author, multi-type distributed machine learning software elements that operate independently or in swarming clusters, whether planned, passive/active response, or adaptive/behaviorally learnt overtime. The system is configured to dynamically oversee the lifecycle of registering, onboarding, testing, workflow automation, management orchestration, system communications, and service chain lifecycle management for multi-variant machine learning engines into virtualized swarms of in memory micro-service instances distributed across networked nodes.

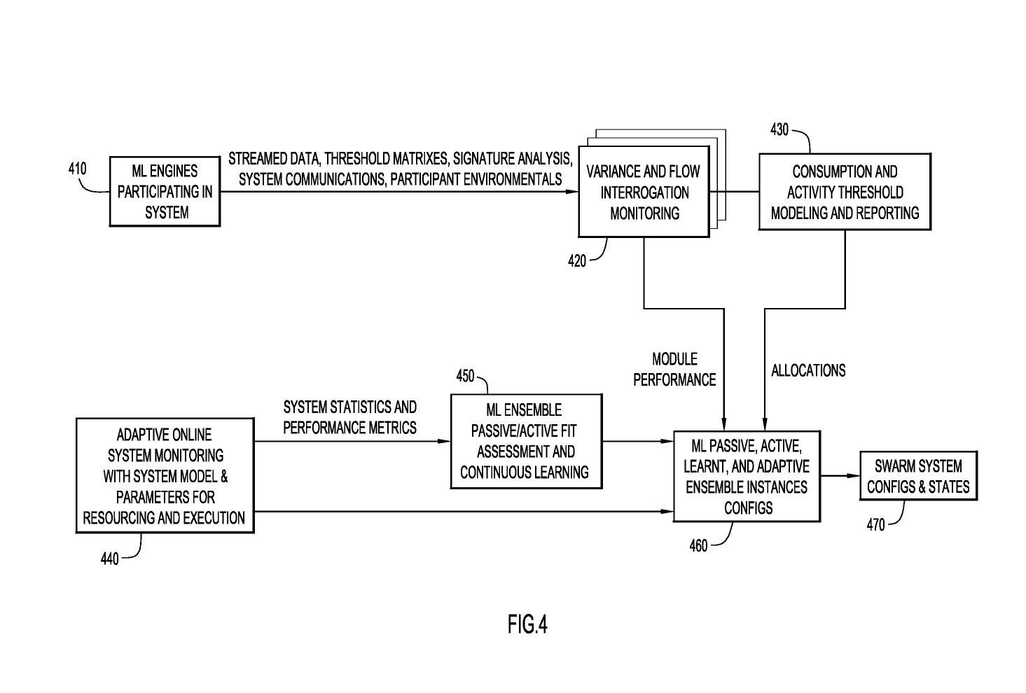

FIG. 4 illustrates a non-limiting approach to managing an ensemble of ML modules in accordance with an example embodiment. As shown, 410 represents a plurality of ML engines that are participating in the system. The ML engines provide streamed data, threshold matrixes, signature analysis, system communications and participant environmental data to variance and flow interrogation monitoring module 420 to produce measures of ML engine performance for each ML engine. At the same time, consumption and activity threshold modeling and reporting module 430 is configured to generate allocations data associated with the plurality of ML engines.

Meanwhile, adaptive online system monitoring with system model and parameters for resourcing and execution module 440 generates system statistics and performance metrics, which are fed to ML ensemble passive/active fit assessment and continuous learning module 450, which itself provides, e.g., recommendations for grouping selected ML engines in an ensemble. These recommendations are fed to ML passive, active, learnt, and adaptive ensemble instances configuration module 460, along with the system statistics and performance metrics generated by module 440. Module 460 then provides its output to swarm system configurations and states module 470, so that, in turn, individual ML engines can be configured to be grouped in an ensemble to operate on a predetermined task.

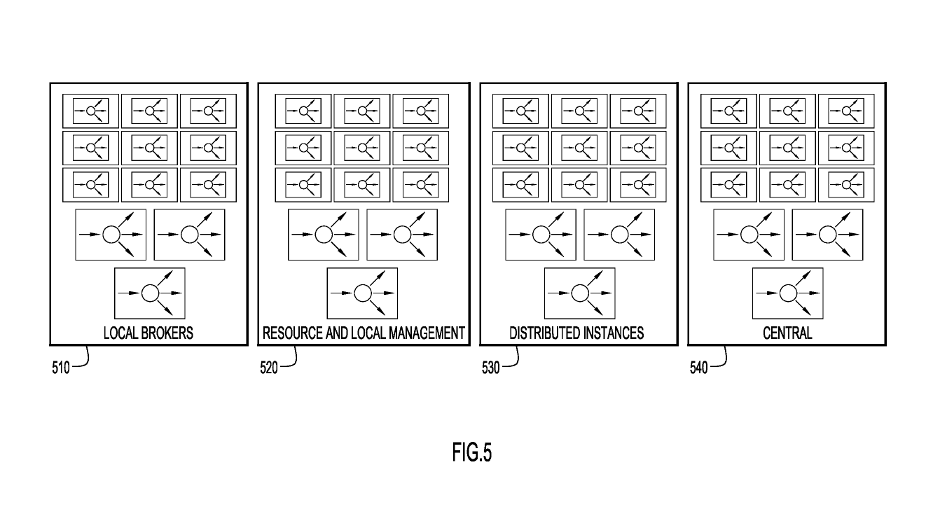

FIG. 5 is a block diagram illustrating that ML module orchestration logic 200 can be used or distributed across a variety of logical and physical boundaries in accordance with an example embodiment. Specifically, local brokers 510, resource and local management entities 520, distributed instances 530, and a central entity 540 may each comprise ML brokers, an ML hypervisor, an ML orchestrator, and an ML local node. Entities 510, 520, 530 and 540 may all be networked together such that they can work independently of one another, of in combination with one another.

Fingerprinting ML Engines

As explained above, ML engines may be grouped together in an ensemble to perform a predetermined task. In order to select appropriate ML engines for a given ensemble, a methodology that assigns a unique signature or fingerprint to each ML engine under consideration is provided.

More specifically, ML module orchestration logic 200 is configured to identify and register attributes and behaviors about the machine learning software code to develop multidimensional fingerprint profiles—a process referred to as “fingerprinting.” For example, the system manages the dynamic fingerprint profiles within an orbital neighborhood, defined as a community of edge nodes that are physically close in proximity. The system may further identify multi-scopic views for machine learning software code and policies per user or machine.

In an embodiment, hypervisor 210 is configured to perform identity tagging, profiling, fingerprinting, and lifecycle management of ML engines 100 distributed throughout networked environments. Hypervisor 210 may be configured to generate a fingerprint or unique identifier for each ML engine 100 based on, e.g., native code/language, underlying methodology, job execution time, required and used RAM, data features and attributes, and other metadata. Hypervisor 210 can then use the generated fingerprint to manage learning about a given ML engine and its potential associations and groupings with other ML engines.

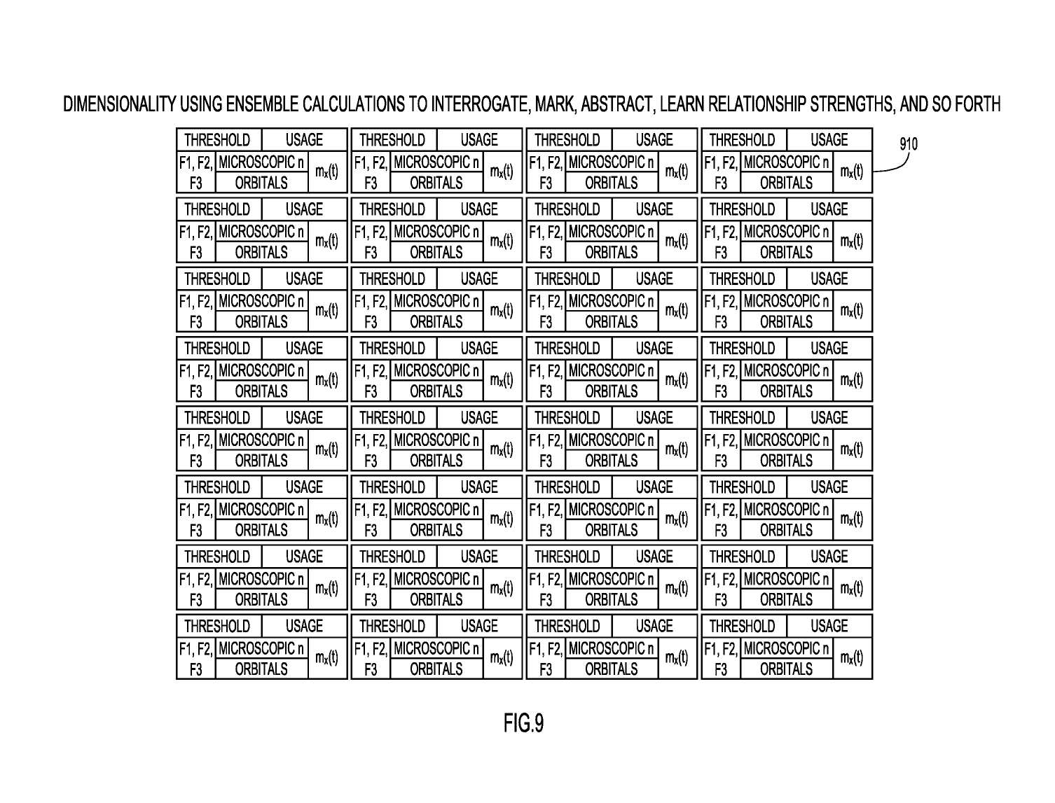

In accordance with one possible implementation, the techniques of fingerprinting comprise a series of persistent system monitor functions that track and uniquely identify digital objects and jobs by mining ML engines and machine learning related environmental metadata. The fingerprint may be derived from each distinct algorithm, dataset, and execution metric and may be stored in a reference library to inform orchestration and job execution via, e.g., orchestration master 220. In addition to the reference library of fingerprints, hypervisor 210 may also maintain a multi-scopic dimensional view and models (FIG. 9) of each ML engine 100 in the system.

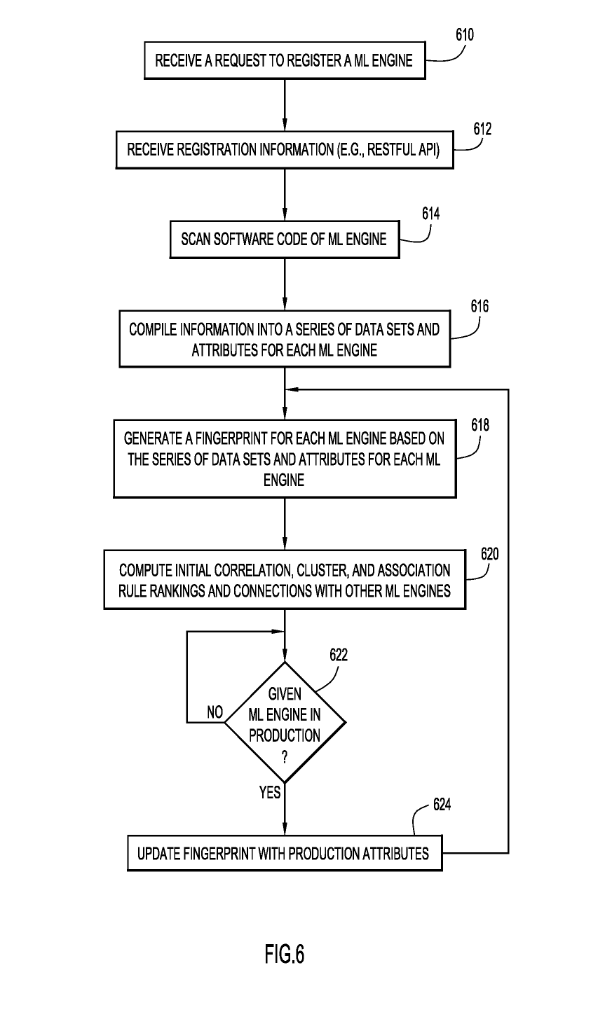

FIG. 6 is a flow diagram that depicts operations associated with generating a fingerprint or unique signature for a given ML module in accordance with an example embodiment. The operations depicted in FIG. 6 may be performed by hypervisor 210, but could also be performed by another component of ML module orchestration logic 200.

At 610, a request to register a ML engine from a unique author or owning organization is received. At 612, several pieces of information are received by ML engine owner including registration information and RESTful API information. At 614, the software code of the ML engine is scanned for inspection and code characteristics abstraction. That is, the system acts as a code inspector that interrogates the ML engine software code to obtain a host of parameters including, e.g., model or method type, hardware and software operating system requirements, type of input/output, functional correctness, performance metrics, security, reliability and statistical information, control features, etc.

At 616, the collected information may then be compiled into a series of data sets and attributes that map characteristics and identifiable feature to each ML component/service associated with each ML engine execution and software run.

At 618, the system generates a fingerprint or profile dataset that is used, initially, to catalog the ML engine. The fingerprint or unique signature may then be stored, perhaps in a tokenized manner, for ingestion and assessment by other components of the ML module orchestration logic 200.

At 620, and in connection with grouping ML engines for ensembles, the system computes initial correlation, cluster, and association rule rankings (FIG. 3) and connections with other ML engines (based on, e.g., authors, company, math used, data ingested, processing parity, etc.) on the software and math aspects of the ML engine. Operation 620 may also abstract identifying attributes and calculate relative neighborhood related markers and signatures, which allow for initial pairing for orbital neighborhoods, threshold ranges for other orbital neighborhoods, and a series of location markers for in production ongoing interrogations.

At 622, it is determined whether a given ML engine is in production, i.e., is operational in the field. If yes, then at 624, attributes associated with production (such as consumption, behavior, failures) can be obtained and the fingerprint updated or re-computed at operation 618. As a result, the ML engine may be reassigned to a different ensemble at operation 620. Multi-scopic self-learning system components can be configured to learn and adapt based on incoming data feeds, derived and calculated data from combined mathematical calculation, and system inventory storing.

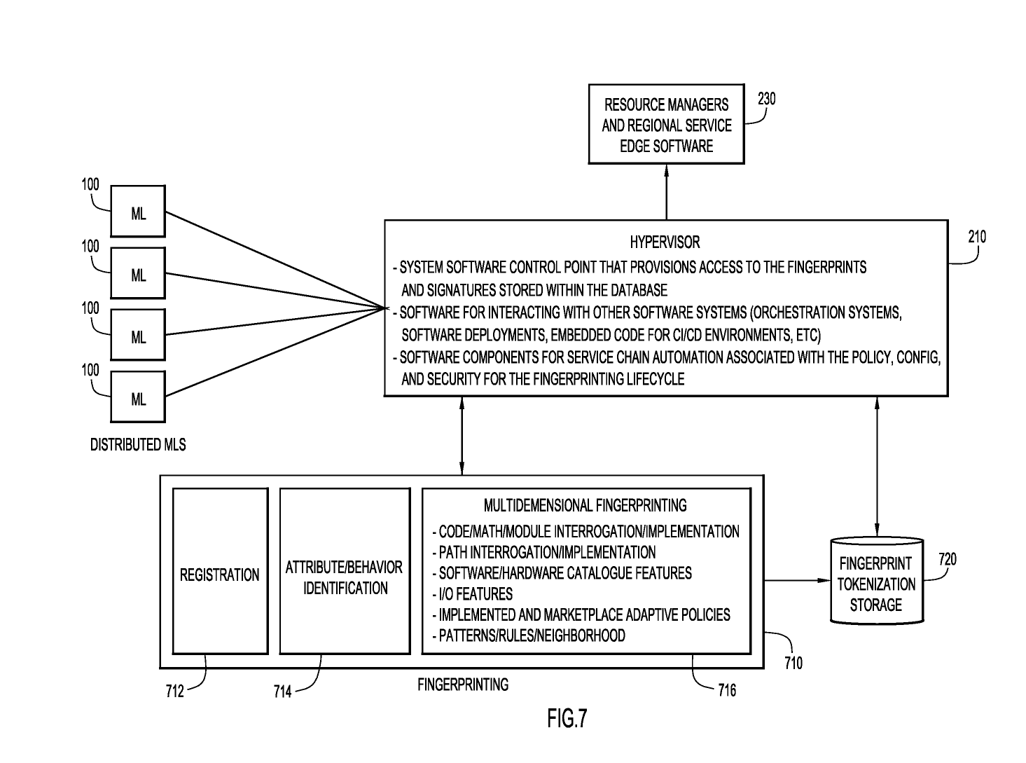

FIG. 7 is a block diagram illustrating functionality in connection with generating a fingerprint or unique signature for a given ML module in accordance with an example embodiment. As shown, ML engines 100 are each in communication with hypervisor 210. As explained above, hypervisor 210 is configured as a control point that provisions access to the generated fingerprints stored within a database 720, and interacts with other components including orchestration master 220. Hypervisor 210 may also be configured to orchestrate service chain automation.

In connection with the fingerprinting function, 710, hypervisor 210 may be configured to manage registration 712 during which a ML engine owner makes a ML engine available to the system. At 714, attributes and behavior of the ML engine are identified and collected. Multidimensional fingerprinting 716 can then performed based on a host of attributes including: software code or math used, path, software and hardware requirements, I/O features, polices, and patterns, rules or neighborhood. The resulting fingerprint might be in the form of an alphanumerical key, for example, and stored in tokenized storage 720, from which hypervisor 210 can create ensembles and provide associated configuration information to resource managers and regional service edge software 230, as appropriate.

Hypervisor 210 may leverage the fingerprints or unique identifiers in several ways. For example, it can establish a catalog of the ML engine 100 at registration and onboarding; continuously improve the profile throughout the ML lifecycle (consumption, behavior, failures, etc.) based on historic, dynamic, and online learning from past deployments, which better informs current and future management and configuration; compute initial correlation, cluster, and association rule rankings and connections with other ML engines (authors, company, math used, data ingested, processing parity, etc.); inform intent-based, declarative, and mechanistic service automation, orchestration, and assurance systems; and analyze deeper semantic traits to detect program and authorship traits such as
Patterns and rules clusters
Syntactic features
Attributes and clusters
Natural Language Processing (NLP) and deeper learning linguistics and coding styles
Obfuscations detection
Flow of code, math, data ingest, etc.

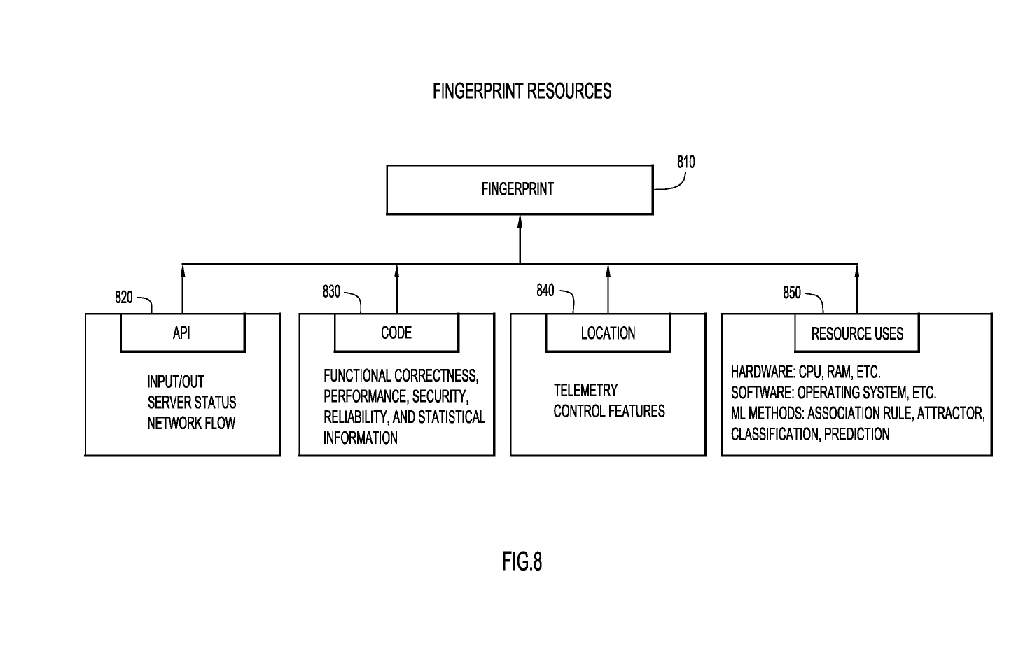

FIG. 8 illustrates examples of avenues via which different attributes for a fingerprint may be gleaned in accordance with an example embodiment. That is, a fingerprint 810 can be built from information received via an API 820, obtained by scanning software code 830, based on a location 840 of a given ML module, and based on resource uses 850. From API 820, it is possible to obtain I/O, server status and network data flow information. From software code 830, it is possible to glean functional correctness, performance, security, reliability, and statistical information. From location 840, it is possible to glean telemetry and control features. And from resources uses 850, hardware and software requirements can be obtained, as well as information about a ML module's association rule, attractor, classification, and prediction metrics.

FIG. 9 is a logical representation of a database that stores information about individual ML modules in accordance with an example embodiment. As shown, information gleaned from multi-scopic ML engine interrogation and learning models lead to multi-dimensional identity models, views, indices, and inventory attributes of distributed ML engines and their many functions. Dimensional views are deeper processing, which includes more interrogation on the software, along with interrogation on the cross reference and intersection of the user/author analysis and the software analysis, and as such producing further range of attributes for unique fingerprinting and verification thresholds of the system. Dimensionality can be leveraged to interrogate, mark, abstract, and learn relationship strengths among the representations 910. Each such representation, for a given microscopic n, might include threshold values, usage statistics, orbital information, and mathematical model functions, F1, F2, F3, and each such microscopic n 910 might be tracked over time, mₓ(t). In this way, and referring again to FIG. 6, a fingerprint can be updated with operational data over time.

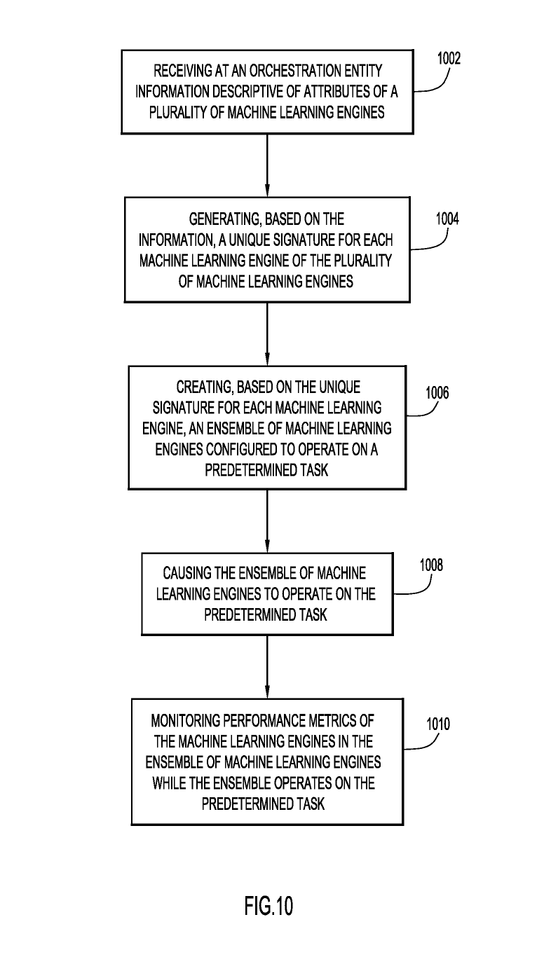

FIG. 10 is a flowchart that depicts operations that may be performed by ML module orchestration logic 200 in accordance with an example embodiment. At 1002, logic 200 receives information descriptive of attributes of a plurality of machine learning engines. At 1004, logic 200 generates, based on the information, a unique signature for each machine learning engine of the plurality of machine learning engines. At 1006, logic 200 creates, based on the unique signature for each machine learning engine, an ensemble of machine learning engines configured to operate on a predetermined task. At 1008, logic 200 causes the ensemble of machine learning engines to operate on the predetermined task. And, at 1010, logic 200 monitors performance metrics of the machine learning engines in the ensemble of machine learning engines while the ensemble operates on the predetermined task.

In sum, the instant embodiments provide the capability to define fingerprint profiles and then automatically select specific sets of machine learning algorithms depending on the job required based on specified variables, attributes, and circumstances.

ML Engine Brokers

Embodiments described herein may also rely distributed ML brokers 1100 (See FIG. 1). This aspect of the instant embodiments was touched upon in connection with communication and broker messaging, handshakes, and negotiations for execution module of orchestration master 220. In one possible implementation, the orchestration system comprises micro-services that swarm across multiple modular resources needed by the virtual network functions, when and where they need them. Pre-set policies allow such virtualized functions to activate additional containers in the cloud, distributed data centers, and/or system environments on an as needed basis.

As mentioned previously, much machine learning may be siloed in function, calculation, and deployment. Orchestration is employed to transition from deploying a single analytics module on a single host to deploying complex and multiple analytics modules on many machines distributed throughout network and infrastructure environments. Thus, orchestration relies on a distributed platform—independent from infrastructure—that can stay online through the lifetime of services and applications, and be resistant to hardware failure and facilitate software updates.

The ML module orchestration logic 200 is configured to provision a virtualized lifecycle management and workflow automation series of capabilities across the distributed ML engines 100, neighborhoods, and management clusters. Logic 200 manages the supervised and unsupervised ML engines 100 distributed throughout network nodes, as well as the combination of other ML engine management approaches into a cluster of insights and data outputs. These insights and outputs could be ingested into individual ML engines and/or ensembles of supervised ML engines.

From a practical perspective, logic 200 communicates with other software elements or components within the service chain of resources and infrastructure components either directly or via API and integration techniques. Logic 200 and its components, including, e.g., ML brokers 1100, may contain a dynamic library of pre-defined declarative workflows that evolve over time into unique mechanistic ways guided by learned logic and adaptive policies to enable optimal resource utilization and orbital neighborhood load balancing.

Local nodes may maintain a series of micro-services that enable handshakes, scheduling, negotiation, and instructions for execution based on northbound, southbound, eastbound, and westbound software control factors.

Logic 200, and more specifically, orchestration master 220, is configured to enable local ML engine to ML engine performance and balancing for exact types of ML functions. For example, an ML engine is used for anomaly detection (regression, time series, etc.), and the same executable may exist on multiple local edge nodes. If one node reaches a saturation point due to an event, the orchestrated node swarms locally with other nodes not experiencing an event to offload ML calculations (e.g., allocate 20% ML capacity to near neighbor without affecting existing calculations). ML brokers 1100 help in the content, data, and messaging actions controlled, commanded, and/or automated by orchestration master 220.

A more distributed orchestration system, using ML brokers 1100 and a micro-services based architecture provides
Polyglot persistence;
Fault tolerance and high availability;
Resistance to hardware failure and software updates;
Scalability; and
Universal utilization.

Those skilled in the art will appreciate that a more distributed orchestration system, using ML brokers 1100, more easily enables:
Version tracking and control
Deployment, import/export
ML module scheduling
Configuration management
Service discovery
Automated deployment optimization
Logging/monitoring/alerting
Event handling
Policy and security enforcement and checks
Workflow design, editing, and managing by human or machine
System performance monitoring

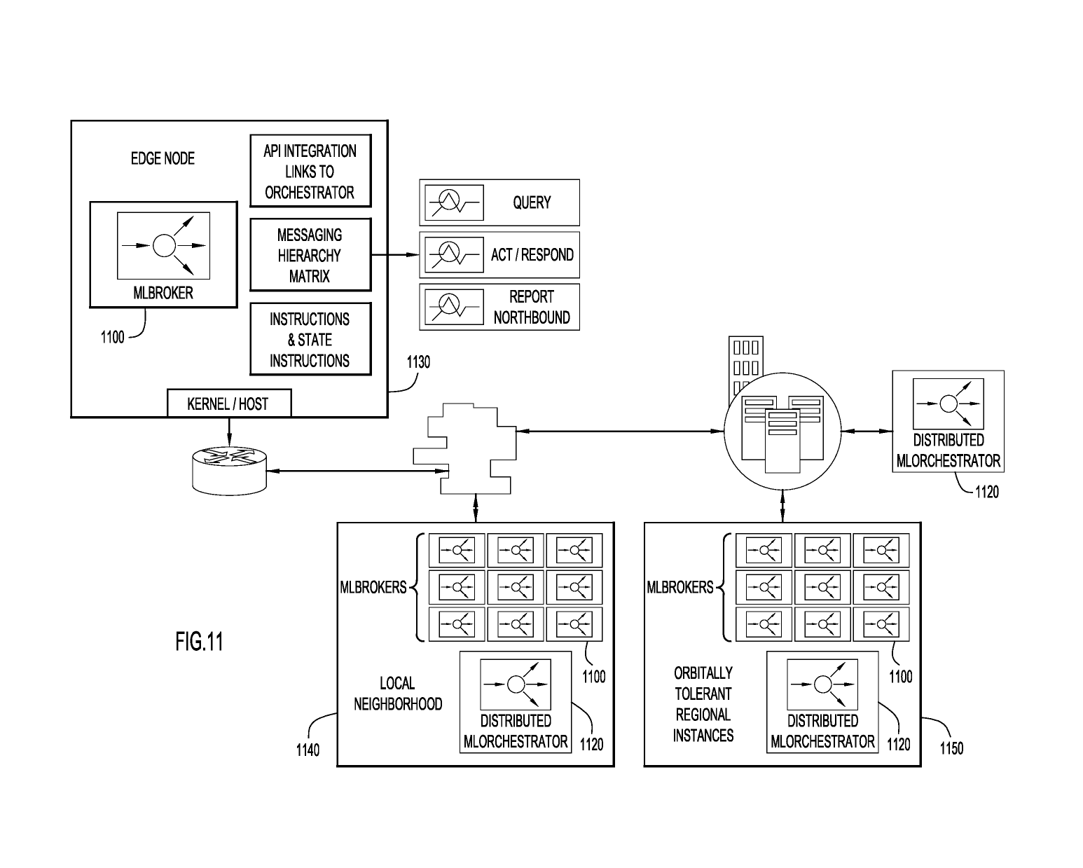

Logic 200, as touched on herein, is configured to perform initial onboarding of ML engines to be orchestrated, and to have service chain automation for managing and allowing ML engine management and ensembles. In this regard, logic 200 enables software programming and API registration that provides an initial record to orchestration manager 220. In an embodiment, orchestration manager 220 stores the records and messages to each ML broker 1100 for ensuring most recent information is locally distributed across the network elements. Orchestration master 220 is also responsible for establishing the authoritative configuration and policy information for distributed ML orchestrators 1120, along with the messaging models for ML Brokers 1100. Reference can be made to FIG. 11, which shows how ML brokers might be distributed across a network and geographical space. ML brokers 1100 can enable distributed ML orchestrators 1120 such that not all of the orchestration responsibility falls exclusively to orchestration master 220.

For example, using ML brokers 1100 it is possible to conduct orchestration staging/onboarding scenario pressure testing, using, e.g., threshold tolerance calculations that continuously learn from production ML workflows and ensemble neighborhood performance and usage, via communication with ML brokers 1100. ML brokers can also assist with capacity pressure testing simulation through carney-like (x % small production time-based deployments, with atomic fallback recovery) for swarm or grouping ensemble clusters for ML swarm passive, active, and adaptive ML resource facing service chain automation. Logic 200 in combination with ML brokers 1100 and distributed ML orchestrators 1120 may also be configured for probing and discovery of general system elements, along with ML engine specific calculations and workflow service chain automation (location, edge device, data, configuration, policy, state, etc., elements for the viable execution of the ML engine) to execute the ML engine participating, management, and ensemble swarming service chaining functions.

Once ML engines 100 are participating in their local neighborhoods and are in communication with corresponding ML broker 1100, then orchestration master 220 can establish a series of functions to help monitor, manage, adapt, and improve performance and assurance.

For example, orchestration master 220 and/or distributed ML orchestrators 1120 may establish a listening orchestration function for feeding algorithms that calculate the ongoing approach to brokering the messaging for ensemble brokering and orchestration in neighborhoods, along with performance improvement options for users.

Further, orchestration master 220 and/or distributed ML orchestrators 1120 can continually interrogate the orchestrated flows and messages identifying and modeling ensemble techniques within the orchestrated system that worked in one neighborhood and may or will work in other neighborhoods (“may” may be determined by human verification/investigation, whereas a “will work” may be sent to ML brokers 1100 to implement via machine-based mechanistic automation approaches).

Orchestration master 220 and/or distributed ML orchestrators 1120 can continually interrogate the flows and messages identifying performance improvements for ML engine service chain automation, utilizing unique flow signatures (data, ML engine performance, amount of messages/negotiations, popularity in events, etc.). This functionality may be based on the orchestrated flows and system communications, which help provide performance optimization inputs or provide “exportables” via API consumption insights into resource managers, software code identifiers, or other 3^{rd} party service chain automation software.

Orchestration master 220 and/or distributed ML orchestrators 1120 can further provide embedded service assurance and neighborhood participation dimensional factors that provision a continuous flow of lifecycle metrics relating directly to the ML automation flows and ML service chain assurance criteria, whether intent, declarative, or mechanistic/adaptive approaches. These components can also provide ML intelligence on local ML-to-ML automation, scaling/borrowing, and local ML execution coordination, within hierarchical classifiers.

Orchestration master 220 and/or distributed ML orchestrators 1120 can still further provide monitoring and pre-emptive service chain healing that incorporates ML engine attributes and ranges for scaled trial and test remediation or full remediation if confidence is high (e.g., remediation validated in past situations within comparable neighborhoods).

Self-learning usage and performance factors can be used for orchestrating the integration of distributed ML brokers 1100 within neighborhoods or peering orbits.

Advanced cluster, attractors, and association algorithms may be performed in ensemble approaches, abstract thresholds of orbital relationships and probabilistic co-occurrences for improving potential neighboring factors. Such calculations inform user or machine options, recommended actions, or proactive system commands to take action.

As mentioned, orchestrator master 220 is the central authority for the distributed system, but elements of the system may be distributed in context of distributed ML orchestrators 1120 that act in authority based on the continuously distributed state, configuration, and policy parameters set by orchestrator master 220.

Orchestrator master 220 monitors, manages and maintains authoritative state of automation, workflows, policies, and other instructions that are programmed via system software or via APIs, and can interoperate with other service chain automation, orchestration and systems.

Orchestrator master 220 also provides a viable state configuration file/data element for distribution of the parameters and instructions that is delivered to distributed ML orchestrators 1120 and ML brokers 1100 as the running state. Running state may be constantly under review and updated or optimized based on the ebbs and flows of the system.

Orchestrator master 220 further provides coordination and command/control for ML-to-ML and/or ML in need of local support from other neighbors. Classifiers may generate unique automation and orchestration flow signatures that inform orchestrator master 220 on best actions, risk factors, anomaly behavior, and ML service chain specific usage trending.

With reference to FIG. 11, distributed ML orchestrators 1120 maintain orchestration guidelines and parameters across the ML brokers 1100 that are querying, responding, reporting, and monitoring the distributed ML engines 100, and host centralized adaptive orchestration software that learns about ML engine orchestration peering, distribution, and bundles for replication to other edge environments or other orbital neighborhoods.

Local neighborhoods 1140 maintain a broker-to-broker software environment. ML brokers 1100 talk to each other within the parameters of system guidelines and with the query functionality to the orchestration master 220 and/or distributed ML orchestrators 1120 for possible other negotiation options.

Orbitally calculated neighborhoods 1150 within local regions are dynamically virtualized for orchestration management functionality based on standard parameters or event-based ebbs and flow dynamic parameters managed by ML module orchestration logic 200 and matrices northbound and southbound that continuously interrogate the flows.

The ML brokers 1100 themselves are system elements for dynamic joins and swarm orchestration. ML brokers 1100 publish attributes, data, bins, and performance. More specifically, ML brokers 1100 aggregate links into a virtual instance and in real time to near real time communicates with orchestration master 220 and/or distributed ML orchestrators 1120.

Local node (e.g., hosting edge node 1130) maintains a series of microservices that have the ML swarming orchestration functionality for handshakes, scheduling, negotiation, and instructions for execution based on northbound orchestration guidelines.

Local neighborhoods 1140 maintain a broker to broker software environment. ML brokers 1100 talk to each other within the parameters of orchestration workflows and guidelines. ML brokers 1100 maintain light weight query functionality to local ML engines 100 and orchestration control points (i.e., orchestration master 220 and/or distributed ML orchestrators 1120). ML brokers 1100 continuously seek out “need/request” messages and process locally within informed state (local authority or local swarm authority set by a configuration/policy) or perform other negotiation based on human and machine ranges of options, thresholds, and performance considerations.

Each ML broker 1100 may act independently with a single unsupervised or supervised ML engine 100 instance or may swarm locally to test multiple ML engine models found within local in-memory parameters and policies.

ML brokers 1100 may provision automation workflow to kick in passive or active switch on/over of ML engine(s) 100 that will be paired.

ML brokers 1100 may also establish messaging flows that allow for data ingestion from the source data, by copying from an ML engine 100, or making ML engine output data to be accessible and ingested into ML engine ensemble virtualized instances.

ML brokers 1100 then monitor the execution of the virtual ensemble instance and maintain the monitoring for the lifecycle of the instance. This may include performance, risks, and flow analysis.

When an ensemble instance seizes for any reason, then ML broker 1100 and orchestration master 220 and/or distributed ML orchestrators 1120 fall back to managed states of the service chains prior to the instance or revised by human or machine from the learnt experiences of the instance.

It is important to highlight that orchestration master 220 and/or distributed ML orchestrators 1120 also permit the use of custom scripts for more advanced workflow and API design that is purposefully designed to handle the unique and growing needs of the distributed ML engine environments, situations, and use cases. This can be important to allow for user-created scripts and workflows, which include problem identification scripts, configuration parsing scripts, and other transitional and longer-term approaches that help toward the goal of improving the return on investment of ML engines and the higher quality analytic output potential of ensemble approaches.

ML Engine Resource Monitoring and Management

As shown in FIG. 2, a resource manager 230 is provided as part of the overall system and ML module orchestration logic 200. The following provides additional details in connection with the resource manager 230.

Resource manager 230 may be configured to maintain real-time awareness, service transacting, and state monitoring of devices and programs in a distributed network. These specialized managers provide visibility and control, as well as optimal, dynamic resource utilization. The resource manager 230 manages the machine learning algorithm performance specifications and other network elements, such as compute nodes/servers, firewalls, load-balancers, memory, disk-space, etc. The resource managers 230 address not only network and compute resources, but also machine learning and deep learning modules and their associated characteristics, whether a single software executable that operates independently in the resource plane or groupings of software executable engines working together intentionally or dynamically.

Although software automation and distribution is used for virtual machines and other software defined network infrastructures, existing approaches are insufficient for handling the multi-factor aspects and required functions for ML engines 100. These approaches are often manual and intent-based in functionality or directly handle infrastructure resources. They do not address, for example, the multi-factor ensemble opportunity described herein. Ensemble classifiers and interrogators to inform, let alone perform system actions, are not presently available, especially across multi-factor considerations at the distributed resource manager levels across networked environments.

Efficient integration and localized management of the resource planes for multi-factor ML Engines is an objective of the embodiments described herein. Resource plane management addresses not only network and compute resources, but also machine learning and deep learning modules and their associated characteristics.

Presented herein is a computer-implemented method for ML engine resource plane monitoring and managing of service conditions, performance, allocations, and presence within resource planes in which distributed ML engines reside. Multiple functions of a resource manager 230 are described below:

A resource manager 230 may maintain awareness of resource presence for ML engines 100 within the resource planes to understand the resource plane coordinates and, where applicable, other dimensional factors across the other interactive planes of data, system, spatial, policy, etc. By having many multi-factor system-derived presence coordinates, the applied resource manager 230 can monitor and manage the ML engines 100 participating within the resource plane locations that range from physical to virtual instances.

A resource manager 230 may perform continuous supply/demand allocating to a service request, by one or more computing devices, resulting in a combination of individual computing resources identified as responsive to the service request. The resource managers' supply/demand modeling, assurance, and other attributes can assist in the service provisioning within the resource plane for ML engines 100 that are participating within that resource plane. This system capability incorporates software-based mechanisms for continuous multi-type interrogations into the resource plane consumption factors to help ensure the supply/demand real time/near real time situational awareness of the resource conditions. The resource manager 230 may establish a series of conductance thresholds that monitor, rank, characterize, and act on the vibrational variations of the resource plane conditions. Conductance is multi-factor interrogation of the resource plane elements identifying the allowable variances and event threshold aspects of ML engine resources. A self-learning model may be applied, and passive and active conditional responses may be incorporated into the logic of the resource manager 230 for each resource element within the resourcing pool. Modulation techniques may be applied for some entities that may require higher than 90% thresholds tolerance limits, while others may allow for lower percentage acceptance tolerance levels, due to criticality or pliability of the resource plane and the ML engines and/or the resource plane conditions.

A resource manager 230 may be configured to identify and characterize machine learning resources certified as available for participation in a multi-faceted, multi-type monitoring and management service, with continued ability to inspect and adapt to changes in resource identity certifications for ML engine clusters, groupings, individual rankings, etc.

A resource manager 230 may profile and orchestrate the resource workloads between certified machine learning resources for both in-band, and within allowance, across multi-plane directions. This is achieved by using interrogation and inspection techniques that monitor network and communication conductance threshold variables with the resource plane, in resource ensembles, and within modulating thresholds based on the network connected resource service chains of hardware, software, and other IT elements the ML engines are operating within. Network flow and communication flow conductance thresholds have intent-based, declarative-based, and situational modulating-based bands where reactive, passive, and proactive actions, and resource managing across resource plane managers and API northbound outputs take place based on the user, machine, or system defined band acceptance criteria, whether user defined or machine adaptive. This technique may also apply modulation techniques for some entities which may require higher than 90% threshold tolerance limits, while others may allow for lower percentage acceptance tolerance levels, due to criticality or pliability of the resource plane and the ML engines and/or the resource plane conditions

A resource manager 230 may further manage the distribution of locally or remotely available resources within the resource planes of authority for each resource manager 230. Distribution identification, by one or more machine learning resources, determines a cumulative availability over time of each combination or idealistic natural groupings of the resources available for ML engines and ML engine ensembles. Orchestration and distribution ecosystems incorporate the pliability of the plane factors into their own system management functions and full service chain orchestration workflows. Localized distribution of the resource plane service elements may be continuously monitored and interrogated by the ensemble techniques for multi-time based metrics (real time-based through to time bounded), enabling the resource manager 230 to continuously learn optimal, exceptions, and risk mitigation resource plane network empowered segment management.

In accordance with an implementation, resource management software operating on a resource manager 230 discovers available and connected resources within the environments in which the ML engines 100 are distributed. Multi-faceted and multi-type registered and discovered resources are combined into views of resources for ML engines. Intent and declarative defined (registered or broadcasted) profiles used to generate a registered signature are registered. The resource management software operating on a resource manager 230 may further generate, through system performed interrogation of the resource, unique resource signatures significant to ML engine needs. The resource signatures, which may be multi-faceted and multi-type, may be stored in a resource manager database. Further interrogation on signatures may subsequently takes place to perform identification of ranks and categories of the resource conditions across performance, location, availability, and other factors to generate the derived signatures used by the resource manager 230. Initial resource plane certifications may take place within the resource manager system to identify and characterize the range and threshold tolerance of certified participation of resources within the multi-faceted, multi-type monitoring and management service for ML engines and their various instances for ensembles.

Resource assignments and modulation based on discovered conditions takes place for the initial setup of resource plane management per ML engine, ML engine pre-defined ensembles, ML engine dynamic on demand ensembles. Other resource plane instances are registered and given unique “instance” signatures for marking the types of passive and active resource scenarios and deployable instances.

Resource manager multi-faceted and multi-type scheduling enables a programmable, automatable, and mechanistic series of hypervisor instructions and ML engine resource plane oriented state configuration and policy datasets. Datasets can be used by developers who are building custom coded wrappers around the resource manager or datasets ingestible into network management systems, orchestration systems, automation systems, and other such software systems.

As resource planes go into operation for ML engines 100, resource manager 230 may continuously execute supply/demand modeling, assurance, and other attributes to assist in the service provisioning within the resource plane for ML engines that are participating within that resource plane's neighborhoods and clusters. The resource manager 230 may continuously ingest resource plane conditions and execute multi-type interrogations into resource plane consumption factors to help ensure the supply/demand real time/near real time situational awareness of the resource conditions.

Presence and location calculations may be performed in real time and/or temporally defined increments to continuously identify and update location state information. Location state information assists in the resource plane management and signature verifications. Ongoing ensemble interrogations and resource plane environmental inspections may be performed across other dimensional factors that incorporate system, spatial, policy, performance, and resource service chain attributes to ensure resource managers continuously monitor performance ebbs and flows at the resource plane level.

The system described herein thus continuously performs performance and optimization suggestive or machine adaptive function to adapt, modulate, and affect the overall resource plane performance for ML engine instances. This is accomplished by the continued ability to inspect and adapt to changes in resource identity certifications for ML engine clusters, groupings, individual rankings, etc. This is also accomplished by multi-faceted and multi-type interrogations seeking conductance thresholds that monitor, rank, characterize, and act on the vibrational variations of the resource plane conditions. The vibrational variations seek out resonance of the resource plane conditions, continuously seeking out optimization, risk mitigation factors per resource environmental and element, and threshold ranging scenario that allow human and machine tolerance scenario calculations and carney like deployment performance boosting sampling (e.g., pressure testing scenarios, both human and machine based).

The resource mangers 230 may, thus, manage the distribution of locally or remotely available resources within the resource planes of authority for each resource manager 230. Distribution identification, by one or more machine learning resources, may determine a cumulative availability over time of each combination or idealistic natural groupings of the resources available for ML engines and ML Engine ensembles. Orchestration and distribution ecosystems incorporate the pliability of the plane factors into their own system management functions and full service chain orchestration workflows. Localized distribution of the resource plane service elements may be continuously monitored and interrogated by the ensemble techniques for multi-time based metrics (real time-based through to time bounded), enabling the resource manager 230 to continuously learn optimal, exceptions, and risk mitigation resource plane network empowered segment management.

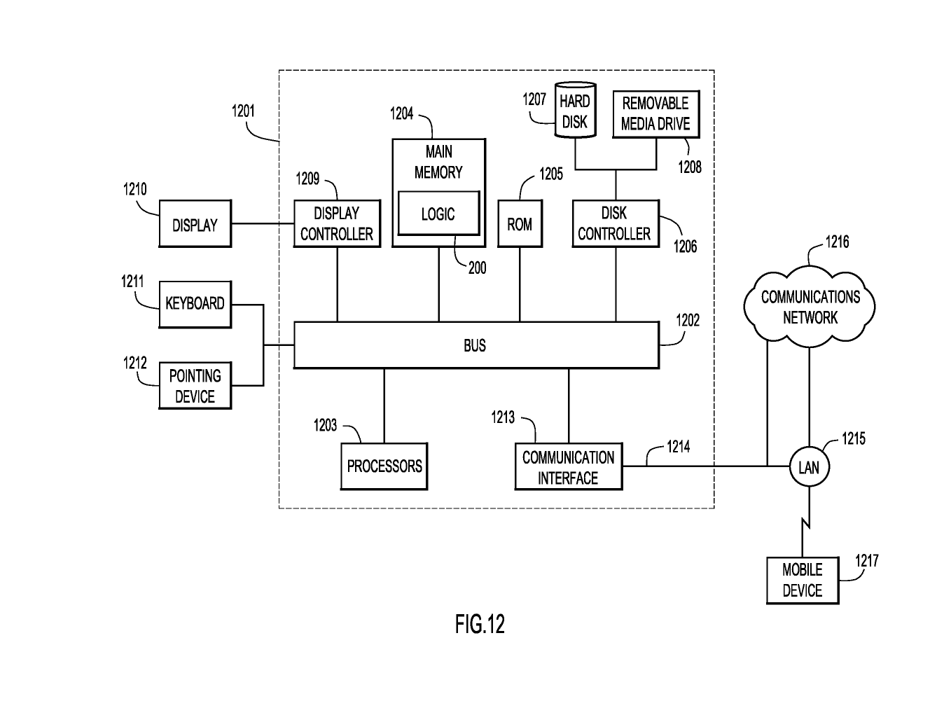

FIG. 12 depicts an apparatus on which the several described embodiments may be implemented. The apparatus, e.g., server 130 referred to above in FIG. 1, may be implemented on or as a computer system 1201. The computer system 1201 may be programmed to implement a computer based device. The computer system 1201 includes a bus 1202 or other communication mechanism for communicating information, and a processor 1203 coupled with the bus 1202 for processing the information. While the figure shows a single block 1203 for a processor, it should be understood that the processor 1203 represents a plurality of processors or processing cores, each of which can perform separate processing. The computer system 1201 may also include a main memory 1204, such as a random access memory (RAM) or other dynamic storage device (e.g., dynamic RAM (DRAM), static RAM (SRAM), and synchronous DRAM (SD RAM)), coupled to the bus 1202 for storing information and instructions (e.g., the logic 200 to perform the operations described herein) to be executed by processor 1203. In addition, the main memory 1204 may be used for storing temporary variables or other intermediate information during the execution of instructions by the processor 1203.

The computer system 1201 may further include a read only memory (ROM) 1205 or other static storage device (e.g., programmable ROM (PROM), erasable PROM (EPROM), and electrically erasable PROM (EEPROM)) coupled to the bus 1202 for storing static information and instructions for the processor 1203.

The computer system 1201 may also include a disk controller 1206 coupled to the bus 1202 to control one or more storage devices for storing information and instructions, such as a magnetic hard disk 1207, and a removable media drive 1208 (e.g., floppy disk drive, read-only compact disc drive, read/write compact disc drive, compact disc jukebox, tape drive, and removable magneto-optical drive). The storage devices may be added to the computer system 1201 using an appropriate device interface (e.g., small computer system interface (SCSI), integrated device electronics (IDE), enhanced-IDE (E-IDE), direct memory access (DMA), or ultra-DMA).

The computer system 1201 may also include special purpose logic devices (e.g., application specific integrated circuits (ASICs)) or configurable logic devices (e.g., simple programmable logic devices (SPLDs), complex programmable logic devices (CPLDs), and field programmable gate arrays (FPGAs)), that, in addition to microprocessors and digital signal processors may individually, or collectively, are types of processing circuitry. The processing circuitry may be located in one device or distributed across multiple devices.

The computer system 1201 may also include a display controller 1209 coupled to the bus 1202 to control a display 1210, such as a cathode ray tube (CRT) or liquid crystal display (LCD), light emitting diode (LED) display, for displaying information to a computer user. The computer system 1201 may include input devices, such as a keyboard 1211 and a pointing device 1212, for interacting with a computer user and providing information to the processor 1203. The pointing device 1212, for example, may be a mouse, a trackball, or a pointing stick for communicating direction information and command selections to the processor 1203 and for controlling cursor movement on the display 1210. In addition, a printer may provide printed listings of data stored and/or generated by the computer system 1201.

The computer system 1201 performs a portion or all of the processing operations of the embodiments described herein in response to the processor 1203 executing one or more sequences of one or more instructions contained in a memory, such as the main memory 1204. Such instructions may be read into the main memory 1204 from another computer readable medium, such as a hard disk 1207 or a removable media drive 1208. One or more processors in a multi-processing arrangement may also be employed to execute the sequences of instructions contained in main memory 1204. In alternative embodiments, hard-wired circuitry may be used in place of or in combination with software instructions. Thus, embodiments are not limited to any specific combination of hardware circuitry and software.

As stated above, the computer system 1201 includes at least one computer readable medium or memory for holding instructions programmed according to the embodiments presented, for containing data structures, tables, records, or other data described herein. Examples of computer readable media are compact discs, hard disks, floppy disks, tape, magneto-optical disks, PROMs (EPROM, EEPROM, flash EPROM), DRAM, SRAM, SD RAM, or any other magnetic medium, compact discs (e.g., CD-ROM), or any other optical medium, punch cards, paper tape, or other physical medium with patterns of holes, or any other medium from which a computer can read.

Stored on any one or on a combination of non-transitory computer readable storage media, embodiments presented herein include software for controlling the computer system 1201, for driving a device or devices for implementing the described embodiments, and for enabling the computer system 1201 to interact with a human user. Such software may include, but is not limited to, device drivers, operating systems, development tools, and applications software. Such computer readable storage media further includes a computer program product for performing all or a portion (if processing is distributed) of the processing presented herein.

The computer code may be any interpretable or executable code mechanism, including but not limited to scripts, interpretable programs, dynamic link libraries (DLLs), Java classes, and complete executable programs. Moreover, parts of the processing may be distributed for better performance, reliability, and/or cost.

The computer system 1201 also includes a communication interface 1213 coupled to the bus 1202. The communication interface 1213 provides a two-way data communication coupling to a network link 1214 that is connected to, for example, a local area network (LAN) 1215, or to another communications network 1216. For example, the communication interface 1213 may be a wired or wireless network interface card or modem (e.g., with SIM card) configured to attach to any packet switched (wired or wireless) LAN or WWAN. As another example, the communication interface 1213 may be an asymmetrical digital subscriber line (ADSL) card, an integrated services digital network (ISDN) card or a modem to provide a data communication connection to a corresponding type of communications line. Wireless links may also be implemented. In any such implementation, the communication interface 1213 sends and receives electrical, electromagnetic or optical signals that carry digital data streams representing various types of information.

The network link 1214 typically provides data communication through one or more networks to other data devices. For example, the network link 1214 may provide a connection to another computer through a local area network 1215 (e.g., a LAN) or through equipment operated by a service provider, which provides communication services through a communications network 1216. The local network 1214 and the communications network 1216 use, for example, electrical, electromagnetic, or optical signals that carry digital data streams, and the associated physical layer (e.g., CAT 5 cable, coaxial cable, optical fiber, etc.). The signals through the various networks and the signals on the network link 1214 and through the communication interface 1213, which carry the digital data to and from the computer system 1201 may be implemented in baseband signals, or carrier wave based signals. The baseband signals convey the digital data as unmodulated electrical pulses that are descriptive of a stream of digital data bits, where the term “bits” is to be construed broadly to mean symbol, where each symbol conveys at least one or more information bits. The digital data may also be used to modulate a carrier wave, such as with amplitude, phase and/or frequency shift keyed signals that are propagated over a conductive media, or transmitted as electromagnetic waves through a propagation medium. Thus, the digital data may be sent as unmodulated baseband data through a “wired” communication channel and/or sent within a predetermined frequency band, different than baseband, by modulating a carrier wave. The computer system 1201 can transmit and receive data, including program code, through the network(s) 1215 and 1216, the network link 1214 and the communication interface 1213. Moreover, the network link 1214 may provide a connection to a mobile device 1217 such as a personal digital assistant (PDA) laptop computer, cellular telephone, or modem and SIM card integrated with a given device.

In sum, there is provided a computer-implemented methodology including operations of receiving at an orchestration entity information descriptive of attributes of a plurality of machine learning engines, generating, based on the information, a unique signature for each machine learning engine of the plurality of machine learning engines, creating, based on the unique signature for each machine learning engine, an ensemble of machine learning engines configured to operate on a predetermined task, causing the ensemble of machine learning engines to operate on the predetermined task, and monitoring performance metrics of the machine learning engines in the ensemble of machine learning engines while the ensemble operates on the predetermined task.

The methodology may further include updating a given unique signature of a given machine learning engine in the ensemble of machine learning engines based on the performance metrics for the given machine learning engine, and recreating, based on the unique signature for each machine learning engine including an updated unique signature of the given machine learning engine, a new ensemble of machine learning engines configured to operate on a predetermined task

In an embodiment, the methodology may further include receiving the information via a registration process by which an owner of each of the plurality of machine learning engines registers with the orchestration entity and supplies attributes to the orchestration entity.

In an embodiment, the methodology may further include receiving the information by scanning software code associated with respective machine learning engines of the plurality of machine learning engines.

In one possible implementation monitoring performance metrics includes invoking an application programming interface (API) identified during the registration process.

In a possible implementation, methodology may further include configuring selected machine learning engines in the ensemble of machine learning engines in a service chain to operate on the predetermined task.

The information may include at least one of a math model, authorship, data attributes, a native code or language, hardware requirements, software requirements, memory requirements, input/output features, data features, configuration, and operational characteristics that vary over time.

In one implementation, causing the ensemble of machine learning engines to operate on the predetermined task comprises sending from the orchestration entity configuration information to resource managers corresponding to respective machine learning engines in the ensemble of machine learning engines.

The methodology may still further include selecting machine learning engines for the ensemble to operate on a predetermined task based on each machine learning engine's clustering metric, attractiveness metric and association metric with respect to other machine learning engines of the plurality of machine learning engines.

Finally, the methodology may include processing outputs from each machine learning engine in the ensemble of machine learning engines by a machine learning engine different from the machine learning engines in the ensemble of machine learning engines.

There is further provided an apparatus that includes an interface unit configured to enable network communications; a memory; and one or more processors coupled to the interface unit and the memory, and configured to: receive information descriptive of attributes of a plurality of machine learning engines, generate, based on the information, a unique signature for each machine learning engine of the plurality of machine learning engines, create, based on the unique signature for each machine learning engine, an ensemble of machine learning engines configured to operate on a predetermined task, cause the ensemble of machine learning engines to operate on the predetermined task, and monitor performance metrics of the machine learning engines in the ensemble of machine learning engines while the ensemble operates on the predetermined task.

The one or more processors may be further configured to update a given unique signature of a given machine learning engine in the ensemble of machine learning engines based on the performance metrics for the given machine learning engine; and recreate, based on the unique signature for each machine learning engine including an updated unique signature of the given machine learning engine, a new ensemble of machine learning engines configured to operate on a predetermined task.

The one or more processors may be further configured to receive the information by scanning software code associated with respective machine learning engines of the plurality of machine learning engines

The one or more processors may be further configured to monitor performance metrics of the machine learning engines by invoking an application programming interface (API) identified during a registration process.

The one or more processors may be further configured to configure selected machine learning engines in the ensemble of machine learning engines in a service chain to operate on the predetermined task.

In one embodiment, the information may include at least one of a math model, authorship, data attributes, a native code or language, hardware requirements, software requirements, memory requirements, input/output features, data features, configuration, and operational characteristics that vary over time.

In still another embodiment, there is provided one or more non-transitory computer readable storage media encoded with software comprising computer executable instructions that, when executed, are operable to: receive information descriptive of attributes of a plurality of machine learning engines, generate, based on the information, a unique signature for each machine learning engine of the plurality of machine learning engines, create, based on the unique signature for each machine learning engine, an ensemble of machine learning engines configured to operate on a predetermined task, cause the ensemble of machine learning engines to operate on the predetermined task, and monitor performance metrics of the machine learning engines in the ensemble of machine learning engines while the ensemble operates on the predetermined task.

The instructions may be further operable to: update a given unique signature of a given machine learning engine in the ensemble of machine learning engines based on the performance metrics for the given machine learning engine; and recreate, based on the unique signature for each machine learning engine including an updated unique signature of the given machine learning engine, a new ensemble of machine learning engines configured to operate on a predetermined task.

The instructions may be further operable to: receive the information by scanning software code associated with respective machine learning engines of the plurality of machine learning engines.

The information may include at least one of a math model, authorship, data attributes, a native code or language, hardware requirements, software requirements, memory requirements, input/output features, data features, configuration, and operational characteristics that vary over time.

The above description is intended by way of example only. Various modifications and structural changes may be made therein without departing from the scope of the concepts described herein and within the scope and range of equivalents of the claims.

What is claimed is:

1. A computer-implemented method comprising:
receiving at an orchestration entity information descriptive of attributes of a plurality of machine learning engines;
generating, based on the information, a unique signature for each machine learning engine of the plurality of machine learning engines;
creating, based on the unique signature for each machine learning engine, an ensemble of machine learning engines configured to operate on a predetermined task;
causing the ensemble of machine learning engines to operate on the predetermined task; and
monitoring performance metrics of the machine learning engines in the ensemble of machine learning engines while the ensemble operates on the predetermined task.

2. The method of claim 1, further comprising updating a given unique signature of a given machine learning engine in the ensemble of machine learning engines based on the performance metrics for the given machine learning engine; and
recreating, based on the unique signature for each machine learning engine including an updated unique signature of the given machine learning engine, a new ensemble of machine learning engines configured to operate on a predetermined task.

3. The method of claim 1, further comprising receiving the information via a registration process by which an owner of each of the plurality of machine learning engines registers with the orchestration entity and supplies attributes to the orchestration entity.

4. The method of claim 1, further comprising receiving the information by scanning software code associated with respective machine learning engines of the plurality of machine learning engines.

5. The method of claim 1, wherein monitoring performance metrics includes invoking an application programming interface (API) identified during the registration process.

6. The method of claim 1, further comprising configuring selected machine learning engines in the ensemble of machine learning engines in a service chain to operate on the predetermined task.

7. The method of claim 1, wherein the information comprises at least one of a math model, authorship, data attributes, a native code or language, hardware requirements, software requirements, memory requirements, input/output features, data features, configuration, and operational characteristics that vary over time.

8. The method of claim 1, wherein causing the ensemble of machine learning engines to operate on the predetermined task comprises sending from the orchestration entity configuration information to resource managers corresponding to respective machine learning engines in the ensemble of machine learning engines.

9. The method of claim 1, further comprising selecting machine learning engines for the ensemble to operate on a predetermined task based on each machine learning engine's clustering metric, attractiveness metric and association metric with respect to other machine learning engines of the plurality of machine learning engines.

10. The method of claim 1, further comprising processing outputs from each machine learning engine in the ensemble of machine learning engines by a machine learning engine different from the machine learning engines in the ensemble of machine learning engines.

11. A device comprising:
an interface unit configured to enable network communications;
a memory; and
one or more processors coupled to the interface unit and the memory, and configured to:
receive information descriptive of attributes of a plurality of machine learning engines;
generate, based on the information, a unique signature for each machine learning engine of the plurality of machine learning engines;
create, based on the unique signature for each machine learning engine, an ensemble of machine learning engines configured to operate on a predetermined task;
cause the ensemble of machine learning engines to operate on the predetermined task; and
monitor performance metrics of the machine learning engines in the ensemble of machine learning engines while the ensemble operates on the predetermined task.

12. The device of claim 11, wherein the one or more processors are further configured to update a given unique signature of a given machine learning engine in the ensemble of machine learning engines based on the performance metrics for the given machine learning engine; and
recreate, based on the unique signature for each machine learning engine including an updated unique signature of the given machine learning engine, a new ensemble of machine learning engines configured to operate on a predetermined task.

13. The device of claim 11, wherein the one or more processors are further configured to receive the information by scanning software code associated with respective machine learning engines of the plurality of machine learning engines.

14. The device of claim 11, wherein the one or more processors are further configured to monitor performance metrics of the machine learning engines by invoking an application programming interface (API) identified during a registration process.

15. The device of claim 11, wherein the one or more processors are further configured to configure selected machine learning engines in the ensemble of machine learning engines in a service chain to operate on the predetermined task.

16. The device of claim 11, wherein the information comprises at least one of a math model, authorship, data attributes, a native code or language, hardware requirements, software requirements, memory requirements, input/output features, data features, configuration, and operational characteristics that vary over time.

17. One or more non-transitory computer readable storage media encoded with software comprising computer executable instructions that, when executed, are operable to:
receive information descriptive of attributes of a plurality of machine learning engines;
generate, based on the information, a unique signature for each machine learning engine of the plurality of machine learning engines;
create, based on the unique signature for each machine learning engine, an ensemble of machine learning engines configured to operate on a predetermined task;
cause the ensemble of machine learning engines to operate on the predetermined task; and
monitor performance metrics of the machine learning engines in the ensemble of machine learning engines while the ensemble operates on the predetermined task.

18. The non-transitory computer readable storage media of claim 17, wherein the instructions are operable to:
update a given unique signature of a given machine learning engine in the ensemble of machine learning engines based on the performance metrics for the given machine learning engine; and
recreate, based on the unique signature for each machine learning engine including an updated unique signature of the given machine learning engine, a new ensemble of machine learning engines configured to operate on a predetermined task.

19. The non-transitory computer readable storage media of claim 17, wherein the instructions are operable to:
receive the information by scanning software code associated with respective machine learning engines of the plurality of machine learning engines.

20. The non-transitory computer readable storage media of claim 17, wherein the information comprises at least one of a math model, authorship, data attributes, a native code or language, hardware requirements, software requirements, memory requirements, input/output features, data features, configuration, and operational characteristics that vary over time.
